(19) United States
(12) Patent Application Publication
(10) Pub. No.: US 2010/0030589 A1
(43) Pub. Date: Feb. 4, 2010

(54) SYSTEM AND METHOD FOR PROCESSING RATING DATA TAGGED TO EXPENSE REPORT ITEMS

(75) Inventor: CHANDRASEKHAR NARAYANASWAMI, WILTON, CT (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: INTERNATIONAL BUSINESS MACHINES CORPORATION, ARMONK, NY (US)

(21) Appl. No.: 12/183,595

(22) Filed: Jul. 31, 2008

(51) Int. Cl. G06Q 10/00

(52) U.S. Cl. 705/5; 705/30

(57) ABSTRACT

A system and method of processing rating data tagged to expense report items that generates an expense report form including at least one line item expense record to be filled out by a user, the at least one line item expense record including at least one tagged expense information field. Input is received from the user and is entering into corresponding expense fields of the at least one line item expense record. The entered input is stored with the at least one line item expense record, and is later processed with a plurality of line item expense records to generate and output one of report data and at least a portion of a travel itinerary based on a plurality of stored tagged expense information. The tagged expense information fields includes one of a transportation information field and a specific business information field, a rating field, a free form comment field, and a rater identification field.

### BACKGROUND OF THE INVENTION

1. Field of the Invention

The present invention generally relates to a system and method that processes rating data tagged to expense report items to generate an expense report form including at least one line item expense record to be filled out by a user, wherein the at least one line item expense record includes at least one tagged expense information field.

2. Description of the Related Art

Frequent business travelers use tools to make travel arrangements and then submit expense reports at the end of travel. Until now, there has been no use of tagging specific information to line items in expense reports for processing this data to benefit future travelers. Collaborative tagging of travel elements such as airlines, trains, hotels, restaurants, etc., can vastly improve the travel experience and planning of the business traveler.

Presently, hotel reservations may be made using ratings provided by independent rating agencies like, Michelin™ and AAA™, and ratings for restaurants may be provided by Zagat™. Sometimes business travelers feel that these ratings are not accurate, especially since one of the independent rating agencies may have rated a room that the negotiated rate of the particular company of the business traveler does not include. Certain elements such as local taxi company may have no publicly available rating whatsoever. In addition, sometimes the rating is done by a local agency and may not take into account the requirements and preferences of foreign travelers, or travelers with unique preferences or needs.

### SUMMARY OF THE INVENTION

In view of the foregoing and other exemplary problems, drawbacks, and disadvantages of the conventional methods and structures, the exemplary aspects of the present invention provide a method and system processing rating data tagged to expense report items may, therefore, provide significant cost savings and beneficial efficiencies to an organization's travel procedures.

An exemplary aspect of the present invention includes a method of processing rating data tagged to expense report items, the method including generating an expense report form including at least one line item expense record to be filled out by a user, the at least one line item expense record including an expense date field, an expense category field, an expense amount field, and tagged expense information fields, receiving input from the user at an input device and entering the input into corresponding the expense fields of the at least one line item expense record, storing the entered input of the at least one line item expense record, and processing the stored input of a plurality of line item expense records to generate and output report data at an output device based on a plurality of stored tagged expense information, wherein the tagged expense information fields comprise: one of a transportation information field and a specific business information field, a rating field, a free form comment field, and a rater identification field.

Another exemplary aspect of the present invention includes the transportation routing information field further comprises at least one from the group of, an origination and destination routing information field, one of a time of departure field and a flight number field, and a common carrier field.

Another exemplary aspect of the present invention includes the specific business information field further comprises at least one from the group of, a specific business name field, a city and state field, a street address field, a phone number field, and a Uniform Resource Locator (URL) field.

Another exemplary aspect of the present invention includes the generated report data ranks high and low rated travel-related expense items, listed by data entered in the transportation routing information field according to data entered in at least one from the group of, the origination and destination routing information field, the one of a time of departure field and a flight number field, and the common carrier field.

Another exemplary aspect of the present invention includes the generated report data ranks high and low rated expense items, listed by data entered in the specific business information field according to data entered in at least one from the group of, the city and state field, the expense category field, and the rater identification field, and wherein the generated report data is indexed enabling retrieval of information based on one of a specific rating or data entry.

Another exemplary aspect of the present invention includes the generated report data ranks high and low rated expense items, listed by data entered in the rater identification field, wherein the data entered in the rater identification field may comprise one from the group of, rater nationality data, rater age data, and rater dietary preferences data, and wherein the generated report data is indexed enabling retrieval of information based on one of a specific rating or data entry.

Another exemplary aspect of the present invention includes the generated report data ranks high and low rated expense items, listed according to a user travel itinerary, wherein the ranked expense items correspond to user data entered in at least one from the group of, the origination and destination routing information field, the one of a time of departure field and a flight number field, and the common carrier field, and wherein the generated report data is indexed enabling retrieval of information based on one of a specific rating or data entry.

Another exemplary aspect of the present invention includes the generated report data ranks high and low rated expense items, listed according to a user travel itinerary, and wherein the ranked expense items correspond to user data entered in the city and state field.

Another exemplary aspect of the present invention includes a method of processing rating data tagged to expense report items, the method including generating an expense report form including at least one line item expense record to be filled out by a user, the at least one line item expense record including an expense date field, an expense category field, an expense amount field, and tagged expense information fields, receiving input from the user at an input device and entering the input into the corresponding the expense fields of the at least one line item expense record, storing the entered input of the at least one line item expense record, and processing the stored input of a plurality of line item expense records to generate and output at least a portion of a travel itinerary at an output device for a traveling user based on a plurality of stored tagged expense information, wherein the tagged expense information fields comprise: one of a transportation information field and a specific business information field, a rating field, a free form comment field, and a rater identification field.

Another exemplary aspect of the present invention includes the generated at least the portion of the travel itinerary reserves travel accommodations in at least one of the group of, from a specific origination and to specific destination, at a specific time of departure, on a specific flight number on a specific common carrier, and on a specific common carrier, based on data entered in the rating field correlating to data entered in the transportation routing information field.

Another exemplary aspect of the present invention includes the generated at least the portion of the travel itinerary reserves travel accommodations in at least one of at specific business and during a specific time based on data entered in the rating field correlating to data entered in the specific business information field.

Another exemplary aspect of the present invention includes the generated at least the portion of the travel itinerary one of removes and replaces travel accommodations from at least one from the group one of, from a specific origination and to specific destination, at a specific time of departure, on a specific flight number on a specific common carrier, and on a specific common carrier, based on data entered in the rating field correlating to data entered in the transportation routing information field.

Another exemplary aspect of the present invention includes the generated at least the portion of the travel itinerary one of removes and replaces travel accommodations from at least one from the group of, at specific business, and during a specific time, based on data entered in the rating field correlating to data entered in the specific business information field.

Another exemplary aspect of the present invention includes a method including generating an expense report form including at least one line item expense record to be filled out by a user, the at least one line item expense record including an expense date field, an expense category field, an expense amount field, and tagged expense information fields, receiving input from the user and entering the input into the corresponding the expense fields of the at least one line item expense record, storing the entered input of the at least one line item expense record, and processing the stored input of a plurality of line item expense records to generate and output one of report data and at least a portion of a travel itinerary based on a plurality of stored tagged expense information, wherein the tagged expense information fields comprise: one of a transportation information field and a specific business information field, a rating field, a free form comment field, and a rater identification field.

Another exemplary aspect of the present invention includes the transportation routing information field further comprises at least one from the group of, an origination and destination routing information field, one of a time of departure field and a flight number field, and a common carrier field.

Another exemplary aspect of the present invention includes the specific business information field further comprises at least one from the group of, a specific business name field, a city and state field, a street address field, a phone number field, and a Uniform Resource Locator (URL) field.

Another exemplary aspect of the present invention includes data automatically retrieved from a remote database and input to the street address field and the phone number field based on user data input into the specific business name field and the city and state field.

Another exemplary aspect of the present invention includes the rating field further comprises a predefined list of rating items based on user data entered into the expense category field, wherein the user may enter rating data for each of the predefined list of rating items.

Another exemplary aspect of the present invention includes the rater identification field further comprises at least one of the group of, a rater nationality field, a rater age field, and a rater dietary preference field.

Another exemplary aspect of the present invention includes aging tagged expense data entered in the tagged expense information fields linearly over time such that the generated report data and travel itineraries are based on aged tagged expense information, wherein more current tagged expense data has a greater weighting than older tagged expense data.

Another exemplary aspect of the present invention includes a programmable storage medium tangibly embodying a program of machine-readable instructions executable by a digital processing apparatus to perform operations supporting a method of tagging expense report items with rating data, the operations including generating an expense report form including at least one line item expense record to be filled out by a user, the at least one line item expense record including an expense date field, an expense category field, an expense amount field, and tagged expense information fields, receiving input from the user and entering the input into the corresponding the expense fields of the at least one line item expense record, storing the entered input of the at least one line item expense record, and processing the stored input of a plurality of line item expense records to generate one of report data and at least a portion of a travel itinerary based on a plurality of stored tagged expense information, wherein the tagged expense information fields comprise: one of a transportation information field and a specific business information field, a rating field, a free form comment field, and a rater identification field.

Another exemplary aspect of the present invention includes the transportation routing information field further comprises at least one from the group of, an origination and destination routing information field, one of a time of departure field and a flight number field, and a common carrier field.

Another exemplary aspect of the present invention includes wherein the specific business information field further comprises at least one from the group of, a specific business name field, a city and state field, a street address field, a phone number field, and a Uniform Resource Locator (URL) field.

In still another exemplary aspect of the present invention includes data automatically retrieved from a remote database and input to the street address field and the phone number field based on user data input into the specific business name field and the city and state field.

In still another exemplary aspect of the present invention includes the rating field further comprises a predefined list of rating items based on user data entered into the expense category field, wherein the user may enter rating data for each of the predefined list of rating items.

Another exemplary aspect of the present invention includes a system of processing rating data tagged to expense report items, the system including a processor that generates an expense report form including at least one line item expense record to be filled out by a user, the at least one line item expense record including an expense date field, an expense category field, an expense amount field, and tagged expense information fields, an input device that receives input from the user and entering the input into the corresponding the expense fields of the at least one line item expense record, a storage device that stores the entered input of the at least one line item expense record, and an output device to output one of report data and at least a portion of a travel itinerary generated by the processor processing a plurality of stored tagged expense information of the stored input of a plurality of line item expense records, wherein the tagged expense information fields includes one of a transportation information field and a specific business information field, a rating field, a free form comment field, and a rater identification field.

Another exemplary aspect of the present invention includes the transportation routing information field further includes at least one from the group of an origination and destination routing information field, one of a time of departure field and a flight number field, and a common carrier field.

Another exemplary aspect of the present invention includes the specific business information field further includes at least one from the group of a specific business name field, a city and state field, a street address field, a phone number field, and a Uniform Resource Locator (URL) field.

Another exemplary aspect of the present invention includes data is automatically retrieved from a remote database and input to the street address field and the phone number field based on user data input into the specific business name field and the city and state field.

Another exemplary aspect of the present invention includes the rating field further comprises a predefined list of rating items based on user data entered into the expense category field, wherein the user may enter rating data for each of the predefined list of rating items.

Another exemplary aspect of the present invention includes the rater identification field further includes at least one of the group of a rater nationality field, a rater age field, and a rater dietary preference field.

Another exemplary aspect of the present invention includes the processor aging tagged expense data entered in the tagged expense information fields linearly over time such that the generated report data and travel itineraries are based on aged tagged expense information, wherein more current tagged expense data has a greater weighting than older tagged expense data.

With these novel features, the present invention may provide the building of a company specific travel element tagging system integrated with travel expense accounting that develops a tagging culture as a product.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a general exemplary embodiment of processing rating data tagged to expense report items, according the present invention;

FIG. 2 illustrates an exemplary embodiment of an expense report form used in collecting processing rating data tagged to expense report items, according the present invention;

FIG. 3A illustrates an exemplary embodiment of a first embodiment of a travel expense line item for processing rating data tagged to expense report items, according the present invention;

FIG. 3B illustrates an exemplary embodiment of a second embodiment of a travel expense line item for processing rating data tagged to expense report items, according the present invention;

FIG. 3C illustrates an exemplary embodiment of a third embodiment of a travel expense line item for processing rating data tagged to expense report items, according the present invention;

FIG. 4A illustrates an exemplary embodiment of a first embodiment of a generated report by processing rating data tagged to expense report items, according the present invention;

FIG. 4B illustrates an exemplary embodiment of a second embodiment of a generated report by processing rating data tagged to expense report items, according the present invention;

FIG. 4C illustrates an exemplary embodiment of a third embodiment of a generated report by processing rating data tagged to expense report items, according the present invention;

FIG. 4D illustrates an exemplary embodiment of a fourth embodiment of a generated report by processing rating data tagged to expense report items, according the present invention;

FIG. 5 illustrates an exemplary embodiment of rater identification data for processing rating data tagged to expense report items, according the present invention;

FIG. 6 illustrates an exemplary embodiment of a travel itinerary generated by processing rating data tagged to expense report items, according the present invention; and

FIG. 7 illustrates an exemplary embodiment of a logic flowchart of entering and processing rating data tagged to expense report items, according the present invention.

### DETAILED DESCRIPTION OF EXEMPLARY EMBODIMENTS OF THE INVENTION

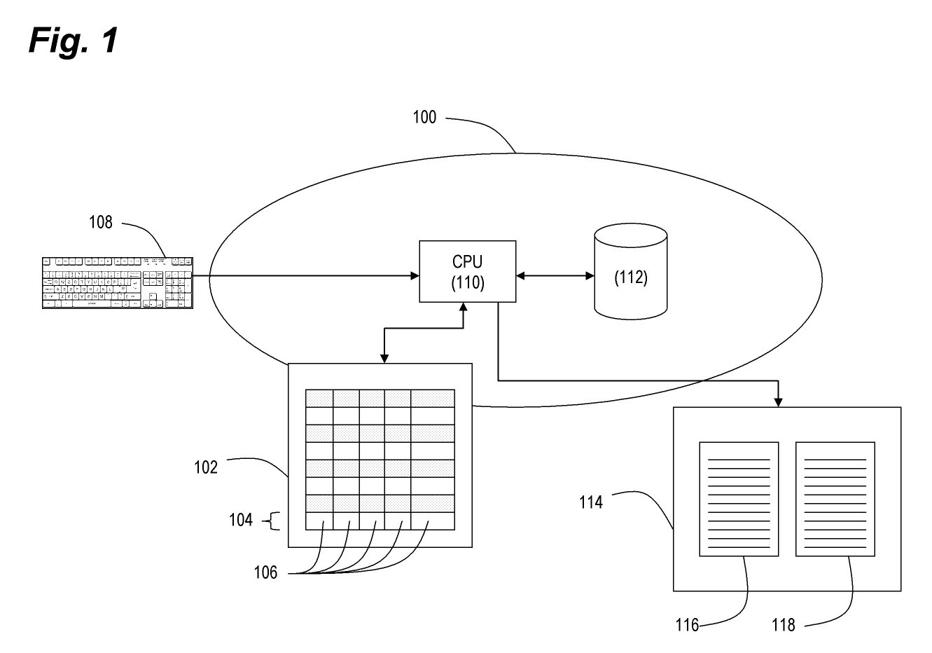

Referring now to the drawings, and more particularly to FIGS. 1-7, there are shown exemplary embodiments of the system and method of the present invention.

### Overview

Generally, this invention attempts to build a company specific travel element tagging system that is integrated with travel expense accounting that develops a tagging culture as a product.

When travel expense reports are filled by business travelers, the present invention may give travelers a quick and easy way to rate each particular travel item. The traveler must ordinarily enter an airline ticket number, date of travel or other related travel expense data. An ease of use of the present invention is that if the traveler has to fill out an expense report, it will only be a small additional step to tag or rate a particular travel item, e.g., a particular flight, or meal a particular restaurant. It is much simpler to perform this activity at the same time of compiling the expense report compared to asking the traveler to do this separately. Hotel bills normally have to be itemized for expense reports, and thus, rating various features of the hotel, e.g., rooms, staff, room service, ambience, convenience of location, etc., are easily accomplished.

When this type of travel expense rating takes place within a single business organization, a much more homogeneous view is presented of company-wide travel-related issues, rather than a more heterogeneous view generated by non-company and general population travelers.

For example, after entering standard restaurant expense information, the traveler may then rate the restaurant in various parameters. In addition to rating, free form comments may be made such as, “the restaurant has a good rating but its menu is limited for vegetarians.”

After the expense information and supplemental tagged information is entered for each travel item, the invention performs a travel arrangement element with this data. While making travel arrangements, information about a particular travel item that has been entered by previous travelers may be shown to the traveler in making his schedule or itinerary. If a hotel has poor ratings, a traveler is forewarned and may not book with them. For airlines, travelers may enter tagged information regarding the timeliness of a particular flight in departure and arrival. If there is overwhelming evidence that a particular flight is historically late due to multiple similar ratings from users of a period of time, the traveler or system may book a different flight or allocate a larger time cushion in travel planning. Travelers may also use the ratings when they take important clients out for dinner to quickly identify business that meet certain company standards of quality and service.

Additionally, these rating tags may be aged according to a variety of algorithms. The simplest is to reduce the weight of a tag linearly over time according to the entry date of the rating tag. Tags may be filtered by many elements—nationality, dietary preference, age of traveler, etc. Tags themselves may also be anonymized by the system to preserve privacy.

Another use of such a system is that a company's travel department may negotiate with airlines, hotels, or other travel-related businesses, based on employee's collective rating feedback. If a particular hotel has low ratings, then the hotel charge should be negotiated downward, or the company should remove it from the list of recommended hotels for its employees.

An important feature of this invention is the lightweight nature of capturing travel-related rating data and the creation of beneficial and valuable travel-related information for enterprise travel decisions.

### Exemplary Aspects

Referring again to the drawings, FIG. 1 illustrates the present invention represented by system 100 which generates an expense report form 102 including a number of line item expense records 104 each containing a plurality of expense fields 106. The input is received by a user on an input device 108 and is communicated to CPU 110 running system controlling software that enters the user input into corresponding expense fields 106 of the line item expense record 104. The entered input is then stored in a storage device 110 with other previously stored user input. CPU 110 retrieves and processes stored input of a plurality of line item expense records to generate a report 116 (or partial report data) and/or a travel itinerary 118 (or a portion of a travel itinerary) at an output device 114. An output device 114 may be a printer or a monitor used to display a graphic output. The expense report 102 may be generated and output at the output device 114, printed separately to be filed out by hand and re-entered into the system, or displayed as a web-based or specific application-based program on a monitor or a portable communication device (not shown).

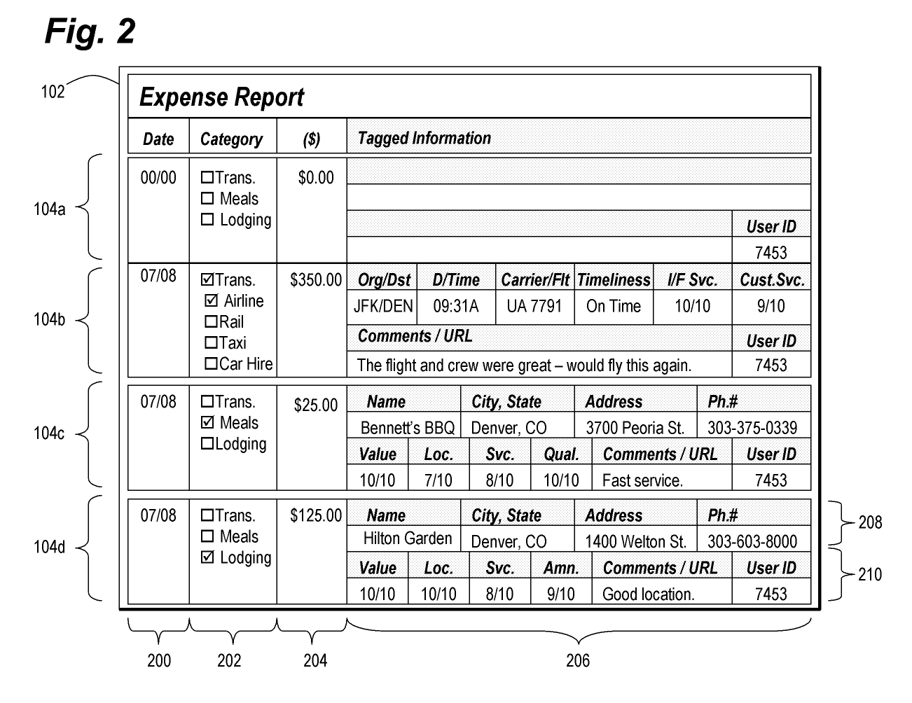

FIG. 2 illustrates if the expense report 102 in more detail showing a number of representative line item expense records 104a-104d. Each of these line item expense records 104a-104d has a date field 200, the category field 202, an amount, or “($)” field 204, and a Tagged Information section 206 that have a first upper date field line 208 and a second lower data field line 210 of data input fields capable of having any number of predefined data entry fields as described below. Line item 104a illustrates a blank line item expense record. Line item 104b illustrates a “Trans.” or “Transportation” expense category where an “Airline” subcategory is further selected. Line item 104c illustrates a “Meals” expense category, and line item 104d illustrates a “Lodging” expense category.

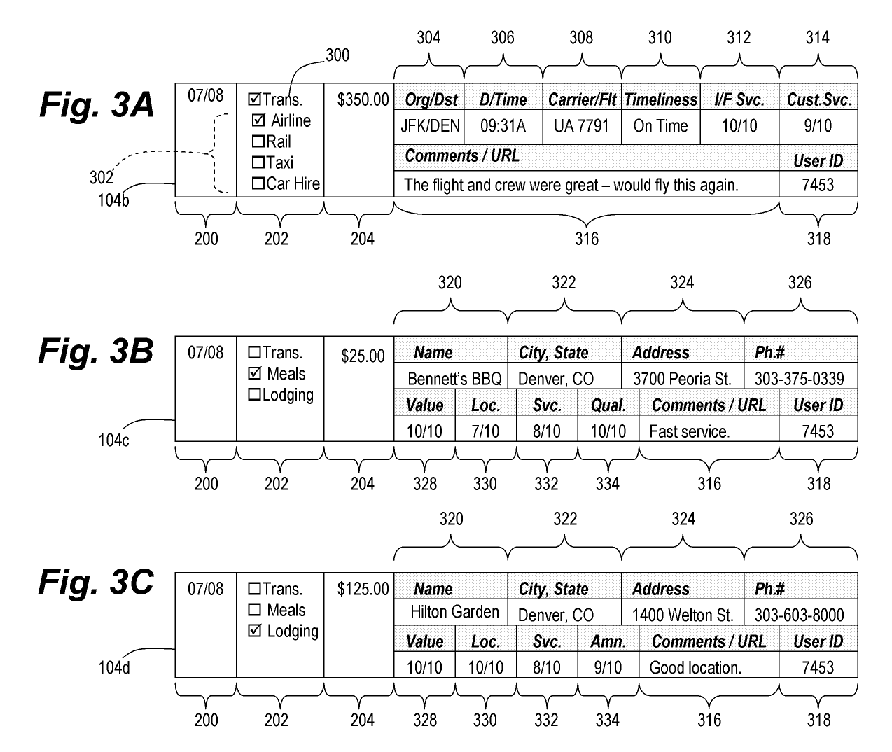

FIGS. 3A, 3B and 3C illustrate each of the line item expense records 104b, 104c and 104d, of FIG. 2, respectively.

FIG. 3A illustrates a selected “Trans.” or “Transportation” expense category 300 where an “Airline” subcategory is further selected. For example, when a user selects the “Trans.” expense category, a sub menu 302 is displayed showing a choice of “Airline,” “Rail,” “Taxi,” and “Car Hire.” When, for example, the “Airline” subcategory is selected, the system automatically populates the Tagged Information section 206 of FIG. 2 with data fields corresponding to the selected category/subcategory. For example, “Org/Dst” or “Origination/Destination” field 304 allows a user to input and origination airport and a destination airport, such as “JFK/DEN.” “D/Time” or “Departure Time” field 306 allows a user to input a departure time at the origination airport, for example as shown, “09:31A.” “Carrier/Flt” or “Carrier/Flight Number” field 308 allows a user to input the airline carrier and flight number, for example as shown, “UA 7791.” “Timeliness” field 310 allows a user qualitatively or quantitatively give information with respect to an on time or late departure and/or arrival of a particular flight, for example as shown, “On Time.” “I/F Svc.” or “In-flight Service” field 312 allows a user to rate the in-flight staff service of a particular flight. For example, a “10/10” corresponds to “10” rating on a scale of 1 to 10. Other designations may be used for entering data in rating fields such as graphical stars, bars, radio knobs, and the like, wherein each graphical representation corresponds to an equivalent numbered value. “Cust. Svc.” or “Customer Service” 314 allows a user to rate the customer service of a particular airline, for example as shown, “9/10.”

Each of these above mentioned data entry fields are specific to the subcategory of “Airline,” and may include generally non-specific date fields such as a free text form “Comments/URL” field 316, and a user ID field 318 where a user identity number may be input corresponding to a stored user profile information. A separate Uniform Resource Locator (URL) field may be provided to incorporate web-address, maps, pictures and other web-based data.

FIG. 3B illustrates a selected “Meals” expense category in expense category 202. For example, when a user selects the “Meals” expense category, the Tagged Information section 206 of FIG. 2 is automatically populated by the system with data fields corresponding to rating restaurants and dining establishments. The “Name” field 320 allows a user to input the name of a dining establishment, and the “City, State” field 322 allows a user to input the city and state of that particular dining establishment. The “Address” field 324 and “Ph.#” or “Phone Number” field of 326 allow a user to input corresponding information for the particular dining establishment manually, or the system may retrieve address and phone number information from a remote location, for example the Internet or electronic Yellow Pages, based on data entered into the “Name” field of 320 and the “City, State” field 322.

A “Value” field 328 allows a user to rate dining value, for example as shown, “10/10.” A “Loc.” or “Location” field 330 allows a user to rate the convenience of the dining establishment location, for example as shown, “7/10.” A “Svc.” or “Service” field 332 allows a user to rate the quality of service, for example as shown “8/10.” A “Qual.” or “Quality” field 334 allows a user to rate the overall quality of the dining establishment, for example a shown “10/10.” Finally, as mentioned above, a free text comment field 316 and a user ID fields 318 are included as described above.

FIG. 3C illustrates a selected “Lodging” expense category in expense category 202. For example, when a user selects the “Lodging” expense category, the Tagged Information section 206 of FIG. 2 is automatically populated by the system that data fields corresponding two rating lodging establishments in a similar manner to invention described above in FIG. 3B.

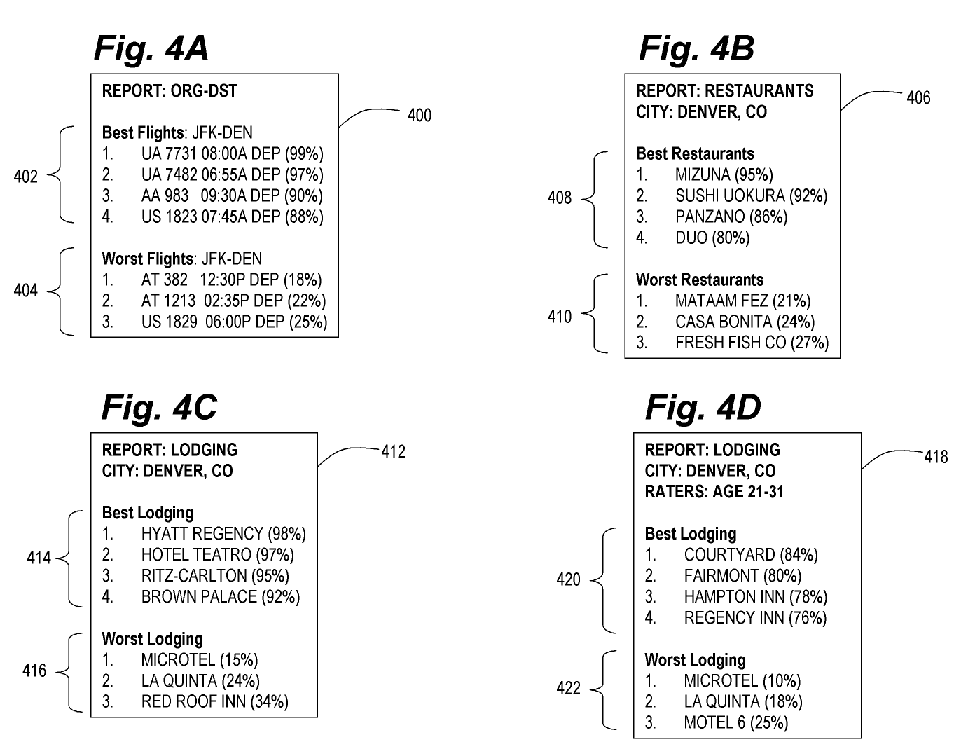

FIGS. 4A, 4B, 4C and 4D illustrate reports that may be generated by the system including ranked cumulative or averaged rating information corresponding to the Tagged Information section 206 of FIG. 2. Additionally, all of the ranked cumulative or average rating information may be indexed to allow either a user or the system to retrieve information based on a specific rating or a specific data entry. For example, this process would allow the retrieval of all restaurants with a rating higher than a specified amount, or the retrieval a rating for a specific restaurant.

FIG. 4A illustrates a report 400 ranking the best 402 and worst 404 flights based on user data with respect either a specific flight or a matching routing. Travel agents or travelers a uses information in selecting flights that of an overall high rating and particularly avoiding flights that have an over a low rating. Ratings generally may be generated based on a single specific field or any combination of fields to give an averaging effect in the rating. For example, flight number 1, in “Best Flights” of FIG. 4A describe the carrier, “UA,” the flight number, “7731,” a time, “08:00A,” whether the time is a departure or arrival time, “DEP,” and a rating value “(99%).” Rating report 400 may also be based on specific travel subcategories 300.

FIG. 4B illustrates a report 406 ranking the best 408 and worst 410 restaurants in the Denver, Colo. area based on user data about restaurants. For example, restaurant number 1, in “Best Restaurants” of FIG. 4B describes a restaurant, “MIZUNA,” and rating value of “(95%).”

FIG. 4C illustrates a report 412 ranking the best 414 and worst 416 lodging in the Denver, Colo. area based on user data about lodging establishments. For example, lodging number 1, in “Best Lodging” of FIG. 4C describes a hotel, “HYATT REGENCY,” and a rating value of “(98%).”

FIG. 4D illustrates a report 418 ranks in the best 420 and worst 422 lodging in the Denver, Colo. area based on user data about lodging establishments and only with respect to raters between the ages of 21 and 31. This user identification data further acts as a filter and may correspond to any other user/rater identification data.

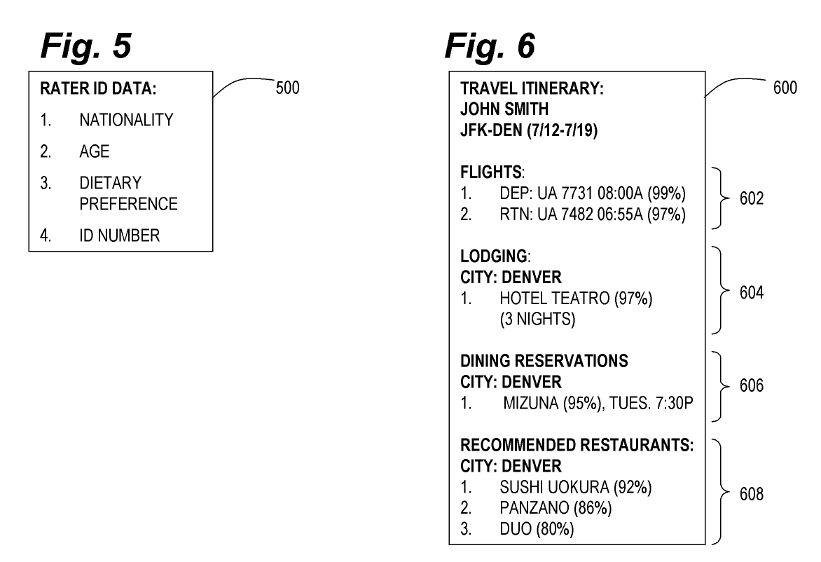

FIG. 5 illustrates “RATER ID DATA” that may be stored in a rater profile including nationality, age, dietary preference, an ID number, and other pertinent information with respect to specific preferences and dislikes of a particular rater. The rater ID data may be anonymized from certain users to protect the ID date from each user. Additionally, a report or report data may be generated base purely upon the rater ID data to look for trends among particular age groups, nationality groups, or other employee group preferences.

FIG. 6 illustrates a travel itinerary 600 generated by the system for a particular traveler, “John Smith,” between a origination location “JFK” and a destination location “DEN” between the dates of July 12 and July 19. The advantage of the present invention allows a system to automatically generate a travel itinerary by reserving flights 602, lodging 604, make dinner reservations 606 and provide recommended restaurants 608 before the traveler is at the destination based on the destination city and the ranked user data of the tagged information section. Additionally, the system of the present invention is able to remove or notify for removal certain travel items or vendors receiving consistently low ratings in the entered tagged travel expense information fields.

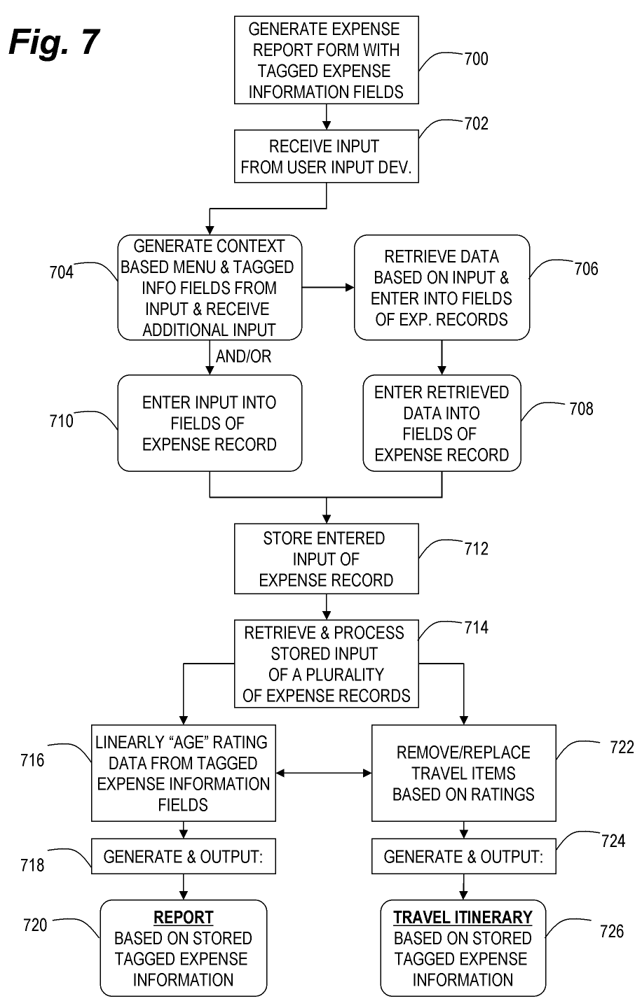

FIG. 7 illustrates a flow chart for the system and method of the present invention that starts at 700 with generating an expense report form (for example, form 102 of FIGS. 1-2), wherein, in addition to the normal expense report entries of date, category, description and amount, include tagged expense information fields. Input is received 702 via a user input device, (for example, 108 of FIG. 1). Next, the system generates a context based menus 704 for a further specifying travel subcategories, (see 302 in FIG. 3A), to which additional information may be input, (e.g., Airline, Rail, etc.), and/or travel category specific tagged information fields 206 based on a selected travel category, (see FIGS. 2, 3A-3C).

A first alternative embodiment retrieves data from a remote location 706, (for example, the internet or an electronic phone directory database), and enters the retrieved information 708 into appropriate tagged information fields of the expense record.

A second alternative embodiment has no automatic look-up function as above, but merely allows a user to enter input data into appropriate tagged expense information fields 710.

All entered information in the expense record is stored 712 in a storage device of the system, (for example, 122 of FIG. 1), and multiple expense record information is accumulated, sorted by various parameters and processed by the system to determine any number of statistically relevant information.

When the system is called upon to generate a report data or at least a portion of a travel itinerary, the system retrieves and begins to process the stored data of a plurality of expense records 714 to determine any type of statistically relevant information relating to data entered in all submitted expense report forms.

Since the focus of the present invention is determining statistically relevant information entered in the tagged information fields of the expense report forms, a first option of generating data from entered user ratings may “age” or weight ratings more current in time than folder ratings 716. This enables the determination of a weighted average of a rating for travel expense line item or particular tagged information field in a travel expense line item. This aging may be performed linearly over time giving a larger weight to the most current ratings and a smaller weight to older ratings.

The system then generates and outputs information either based on “aged” time-based ratings or the actual rating values 718, and generates a report 720 based on the stored tagged expense information, (see FIGS. 4A-4D).

Alternatively, the system may remove or replace particular travel items based on the tagged expense information ratings 722 when generating travel itineraries. Ratings for particular travel items may be subject to the same “aging” of tagged information as described above with respect to reference number 718. The system then generates and output 724 a travel itinerary 726 based on the stored tagged expense information, (see FIG. 6). The advantage of this feature of the invention is that travel planning may be automated to favor certain travel items based on user preferences or may eliminate and/or change certain items based on user feedback in the tagged information fields. For example, if a well regarded hotel is currently undergoing refurbishing that significantly impact the quality of service, the system may respond to a single input user rating or comment that alerts the system to this event where the system changes existing travel reservations or prioritizes another hotel in future travel itineraries.

With these features, the present invention may provide system and method of processing rating data tagged to expense report items that generates an expense report form including at least one line item expense record to be filled out by a user, the at least one line item expense record including at least one tagged expense information field.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A method of processing rating data tagged to expense report items, said method comprising:
generating an expense report form including at least one line item expense record to be filled out by a user, said at least one line item expense record comprising:
an expense date field;
an expense category field;
an expense amount field; and
tagged expense information fields;
receiving input from said user at an input device and entering said input into corresponding said expense fields of said at least one line item expense record;
storing said entered input of said at least one line item expense record; and
processing said stored input of a plurality of line item expense records to generate and output report data at an output device based on a plurality of stored tagged expense information,
wherein said tagged expense information fields comprise:
one of a transportation information field and a specific business information field;
a rating field;
a free form comment field; and
a rater identification field.

2. The method of processing rating data tagged to expense report items according to claim 1, wherein said transportation routing information field further comprises at least one from the group of:
an origination and destination routing information field;
one of a time of departure field and a flight number field; and
a common carrier field.

3. The method of processing rating data tagged to expense report items according to claim 1, wherein said specific business information field further comprises at least one from the group of:
a specific business name field;
a city and state field;
a street address field;
a phone number field; and
a Uniform Resource Locator (URL) field.

4. The method of processing rating data tagged to expense report items according to claim 2, wherein said generated report data ranks high and low rated travel-related expense items, listed by data entered in said transportation routing information field according to data entered in at least one from the group of:
said origination and destination routing information field;
said one of a time of departure field and a flight number field; and
said common carrier field.

5. The method of processing rating data tagged to expense report items according to claim 3, wherein said generated report data ranks high and low rated expense items, listed by data entered in said specific business information field according to data entered in at least one from the group of:
said city and state field;
said expense category field; and
said rater identification field, and
wherein said generated report data is indexed enabling retrieval of information based on one of a specific rating or data entry.

6. The method of processing rating data tagged to expense report items according to claim 1, wherein said generated report data ranks high and low rated expense items, listed by data entered in said rater identification field, wherein said data entered in said rater identification field may comprise one from the group of:
rater nationality data;
rater age data; and
rater dietary preferences data; and
wherein said generated report data is indexed enabling retrieval of information based on one of a specific rating or data entry.

7. The method of processing rating data tagged to expense report items according to claim 1, wherein said generated report data ranks high and low rated expense items, listed according to a user travel itinerary, wherein said ranked expense items correspond to user data entered in at least one from the group of:
said origination and destination routing information field;
said one of a time of departure field and a flight number field; and
said common carrier field; and
wherein said generated report data is indexed enabling retrieval of information based on one of a specific rating or data entry.

8. The method of processing rating data tagged to expense report items according to claim 3, wherein said generated report data ranks high and low rated expense items, listed according to a user travel itinerary, and
wherein said ranked expense items correspond to user data entered in said city and state field.

9. A method of processing rating data tagged to expense report items, said method comprising:
generating an expense report form including at least one line item expense record to be filled out by a user, said at least one line item expense record comprising:
an expense date field;
an expense category field;
an expense amount field; and
tagged expense information fields;
receiving input from said user at an input device and entering said input into said corresponding said expense fields of said at least one line item expense record;
storing said entered input of said at least one line item expense record; and
processing said stored input of a plurality of line item expense records to generate and output at least a portion of a travel itinerary at an output device for a traveling user based on a plurality of stored tagged expense information,
wherein said tagged expense information fields comprise:
one of a transportation information field and a specific business information field;
a rating field;
a free form comment field; and
a rater identification field.

10. The method of processing rating data tagged to expense report items according to claim 9, wherein said generated at least said portion of said travel itinerary reserves travel accommodations in at least one of the group of:
from a specific origination and to specific destination;
at a specific time of departure;
on a specific flight number on a specific common carrier; and
on a specific common carrier,
based on data entered in said rating field correlating to data entered in said transportation routing information field.

11. The method of processing rating data tagged to expense report items according to claim 9, wherein said generated at least said portion of said travel itinerary reserves travel accommodations in at least one of at specific business and during a specific time based on data entered in said rating field correlating to data entered in said specific business information field.

12. The method of processing rating data tagged to expense report items according to claim 9, wherein said generated at least said portion of said travel itinerary one of removes and replaces travel accommodations from at least one from the group one of:
from a specific origination and to specific destination;
at a specific time of departure;
on a specific flight number on a specific common carrier; and
on a specific common carrier,
based on data entered in said rating field correlating to data entered in said transportation routing information field.

13. The method of processing rating data tagged to expense report items according to claim 9, wherein said generated at least said portion of said travel itinerary one of removes and replaces travel accommodations from at least one from the group of:
at specific business; and
during a specific time,
based on data entered in said rating field correlating to data entered in said specific business information field.

14. A method of processing rating data tagged to expense report items, said method comprising:
generating an expense report form including at least one line item expense record to be filled out by a user, said at least one line item expense record comprising:
an expense date field;
an expense category field;
an expense amount field; and
tagged expense information fields;
receiving input from said user and entering said input into said corresponding said expense fields of said at least one line item expense record;
storing said entered input of said at least one line item expense record; and
processing said stored input of a plurality of line item expense records to generate and output one of report data and at least a portion of a travel itinerary based on a plurality of stored tagged expense information,
wherein said tagged expense information fields comprise:
one of a transportation information field and a specific business information field;
a rating field;
a free form comment field; and
a rater identification field.

15. The method of tagging expense report items according to claim 14, wherein said transportation routing information field further comprises at least one from the group of:
an origination and destination routing information field;
one of a time of departure field and a flight number field; and
a common carrier field.

16. The method of tagging expense report items according to claim 14, wherein said specific business information field further comprises at least one from the group of:
a specific business name field;
a city and state field;
a street address field;
a phone number field; and
a Uniform Resource Locator (URL) field.

17. The method of tagging expense report items according to claim 16, wherein data is automatically retrieved from a remote database and input to said street address field and said phone number field based on user data input into said specific business name field and said city and state field.

18. The method of tagging expense report items according to claim 14, wherein said rating field further comprises a predefined list of rating items based on user data entered into said expense category field,
wherein said user may enter rating data for each of said predefined list of rating items.

19. The method of tagging expense report items according to claim 14, wherein said rater identification field further comprises at least one of the group of:
a rater nationality field;
a rater age field; and
a rater dietary preference field.

20. The method of tagging expense report items according to claim 14, further comprising:
aging tagged expense data entered in said tagged expense information fields linearly over time such that said generated report data and travel itineraries are based on aged tagged expense information, wherein more current tagged expense data has a greater weighting than older tagged expense data.

21. A programmable storage medium tangibly embodying a program of machine-readable instructions executable by a digital processing apparatus to perform operations supporting a method of tagging expense report items with rating data, the operations comprising:
generating an expense report form including at least one line item expense record to be filled out by a user, said at least one line item expense record comprising:
an expense date field;
an expense category field;
an expense amount field; and
tagged expense information fields;
receiving input from said user and entering said input into said corresponding said expense fields of said at least one line item expense record;
storing said entered input of said at least one line item expense record; and
processing said stored input of a plurality of line item expense records to generate one of report data and at least a portion of a travel itinerary based on a plurality of stored tagged expense information,
wherein said tagged expense information fields comprise:
one of a transportation information field and a specific business information field;
a rating field;
a free form comment field; and
a rater identification field.

22. The programmable storage medium according to claim 21, wherein said transportation routing information field further comprises at least one from the group of:
an origination and destination routing information field;
one of a time of departure field and a flight number field; and
a common carrier field.

23. The programmable storage medium according to claim 21, wherein said specific business information field further comprises at least one from the group of:
a specific business name field;
a city and state field;
a street address field;
a phone number field; and
a Uniform Resource Locator (URL) field.

24. The programmable storage medium according to claim 23, wherein data is automatically retrieved from a remote database and input to said street address field and said phone number field based on user data input into said specific business name field and said city and state field.

25. The programmable storage medium according to claim 21, wherein said rating field further comprises a predefined list of rating items based on user data entered into said expense category field,
wherein said user may enter rating data for each of said predefined list of rating items.

26. A system of processing rating data tagged to expense report items, said system comprising:
a processor that generates an expense report form including at least one line item expense record to be filled out by a user, said at least one line item expense record comprising:
an expense date field;
an expense category field;
an expense amount field; and
tagged expense information fields;
an input device that receives input from said user and entering said input into said corresponding said expense fields of said at least one line item expense record;
a storage device that stores said entered input of said at least one line item expense record; and
an output device to output one of report data and at least a portion of a travel itinerary generated by said processor processing a plurality of stored tagged expense information of said stored input of a plurality of line item expense records,
wherein said tagged expense information fields comprise:
one of a transportation information field and a specific business information field;
a rating field;
a free form comment field; and
a rater identification field.

27. The system of tagging expense report items according to claim 26, wherein said transportation routing information field further comprises at least one from the group of:
an origination and destination routing information field;
one of a time of departure field and a flight number field; and
a common carrier field.

28. The system of tagging expense report items according to claim 26, wherein said specific business information field further comprises at least one from the group of:
a specific business name field;
a city and state field;
a street address field;
a phone number field; and
a Uniform Resource Locator (URL) field.

29. The system of tagging expense report items according to claim 28, wherein data is automatically retrieved from a remote database and input to said street address field and said phone number field based on user data input into said specific business name field and said city and state field.

30. The system of tagging expense report items according to claim 26, wherein said rating field further comprises a predefined list of rating items based on user data entered into said expense category field,
wherein said user may enter rating data for each of said predefined list of rating items.

31. The system of tagging expense report items according to claim 26, wherein said rater identification field further comprises at least one of the group of:
a rater nationality field;
a rater age field; and
a rater dietary preference field.

32. The system of tagging expense report items according to claim 26, further comprising:
said processor aging tagged expense data entered in said tagged expense information fields linearly over time such that said generated report data and travel itineraries are based on aged tagged expense information, wherein more current tagged expense data has a greater weighting than older tagged expense data.
